(19) United States
(12) Patent Application Publication
(10) Pub. No.: US 2025/0005823 A1
(43) Pub. Date: Jan. 2, 2025

(54) Automated Generation of Immersive Interfaces

(71) Applicants: Nizam Anuar AHMAD, Kuala Lumpur (MY); Sandy KARUNIA, Mapletree Business City (SG); Dian ZHANG, Mapletree Business City (SG); Sumeet KALE, Mapletree Business City (SG); Google LLC, Mountain View, CA (US)

(72) Inventors: Ahmad Nizam Anuar, Iskandar Puteri, Johor (MY); Sandy Karunia, Singapore (SG); Dian Zhang, Singapore (SG); Sumeet Kale, Singapore (SG)

(21) Appl. No.: 18/291,094

(22) PCT Filed: Jul. 22, 2021
(86) PCT No.: PCT/US2021/042701

§ 371 Date: Jan. 22, 2024

(51) Int. Cl. G06T 11/60; G06F 40/289

(52) U.S. Cl. CPC G06T 11/60; G06F 40/289

(57) ABSTRACT

The present disclosure provides systems, methods, and computer program products for performing automated generation of immersive interfaces. For example, a computing device may perform automated generation of immersive interfaces by analyzing a web-based resource comprising textual content, extracting a plurality of textual content segments from the web-based resource, obtaining visual content and audio content related to each respective textual content segment from the plurality of textual content segments, generating target content for an audio-visual display of the web-based resource based on combining at least a portion of each respective textual content segment with the visual content and the audio content related to the respective textual content segment, and providing data descriptive of the generated target content to a computing device for presentation of the audio-visual display of the web-based resource.

### FIELD

The present disclosure generally relates to computer systems. More particularly, the present disclosure relates to the automated generation of immersive interfaces for distributed computing devices via computer networks and internet services.

### BACKGROUND

More than 2.5 quintillion bytes of data are created worldwide each day. Technology providers store billions of gigabytes of content accessible to users via internet search engines and other tools. In addition, users perform over five billion searches worldwide each day to query and access various forms of content. Most of this information exists as long-form text with little or no accompanying visual or audio content.

Content curation generally refers to gathering information relevant to a particular topic and selecting, organizing, and presenting such information in an interesting and meaningful way. Content curation is a time-consuming process requiring specific skills and specialized software. Also, existing methods of content curation are expensive, generally consider only a small fraction of available content, and quickly become outdated in view of increasing amounts of new information generated each day. Further, most content is unavailable in different formats, languages, and interfaces that would otherwise benefit various users around the world.

### SUMMARY

Aspects and advantages of embodiments of the present disclosure will be set forth in part in the following description, or may be learned from the description, or may be learned through practice of the embodiments.

One example aspect of the present disclosure is directed to a system comprising one or more processors and one or more non-transitory computer readable media storing instructions that, when executed by the one or more processors, cause the one or more processors to perform operations for automatically generating immersive interfaces. For example, the operations may include analyzing a web-based resource comprising textual content, extracting a plurality of textual content segments from the web-based resource, obtaining visual content and audio content related to each respective textual content segment from the plurality of textual content segments, generating target content for an audio-visual display of the web-based resource based on combining at least a portion of each respective textual content segment with the visual content and the audio content related to the respective textual content segment, and providing data descriptive of the generated target content to a computing device for presentation of the audio-visual display of the web-based resource.

Another example aspect of the present disclosure is directed to computer-implemented methods for performing automatic generation of immersive interfaces. For example, a computer-implemented method may include analyzing a web-based resource comprising textual content, extracting a plurality of textual content segments from the web-based resource, obtaining visual content and audio content related to each respective textual content segment from the plurality of textual content segments, generating target content for an audio-visual display of the web-based resource based on combining at least a portion of each respective textual content segment with the visual content and the audio content related to the respective textual content segment, and providing data descriptive of the generated target content to a computing device for presentation of the audio-visual display of the web-based resource.

In yet another example of the present disclosure, a non-transitory computer-readable medium stores instructions that, when executed by one or more processors, cause the one or more processors to automatically generate immersive interfaces, for example, by analyzing a web-based resource comprising textual content, extracting a plurality of textual content segments from the web-based resource, obtaining visual content and audio content related to each respective textual content segment from the plurality of textual content segments, generating target content for an audio-visual display of the web-based resource based on combining at least a portion of each respective textual content segment with the visual content and the audio content related to the respective textual content segment, and providing data descriptive of the generated target content to a computing device for presentation of the audio-visual display of the web-based resource.

Other aspects of the present disclosure are directed to various apparatuses, computer systems, non-transitory computer-readable media, computer-implemented methods, user interfaces, and electronic devices. These and other features, aspects, and advantages of various embodiments of the present disclosure will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system for performing automated generation of immersive interfaces in accordance with example embodiments of the present disclosure.

FIG. TA depicts example illustrations showing an example of source content and an example of immersive interfaces automatically generated from the example source content in accordance with example embodiments of the present disclosure.

FIG. 2 depicts a flow diagram of an example method for performing automatic generation of immersive interfaces in accordance with example embodiments of the present disclosure.

FIG. 2A depicts illustrations of an example for performing automatic generation of an immersive interface in accordance with example embodiments of the present disclosure.
example illustrations, including two example immersive interfaces generated from an example piece of long-form text source content in accordance with example embodiments of the present disclosure.

FIG. 3 depicts a flow diagram of an example method for performing automatic generation of immersive interfaces in response to a user request in accordance with example embodiments of the present disclosure.

FIG. 4 depicts example illustrations, including two example immersive interfaces generated from an example piece of long-form text source content in accordance with example embodiments of the present disclosure.

FIG. 5 depicts a flow diagram of an example method for processing a request to generate an immersive interface in accordance with example embodiments of the present disclosure.

FIG. 6 depicts a block diagram of an example computer system that may be used to perform one or more operations in accordance with example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to improving various types of interfaces presented to users including but not limited to long-form text content using automatically generated immersive interfaces which may be created in a variety of immersive formats. In particular, examples described in the present disclosure enable automated transformation of source content into immersive user interfaces. In addition, the present disclosure also enables users to automatically transform their own content into immersive user interfaces. Further, examples of the present disclosure provide improvements in the automated processing and integration of large volumes and various forms of textual, visual, audio, and other types of content as compared to existing approaches. Further, a platform that enables content providers to automatically convert content into immersive user interfaces and surface that content to users through search engines and other techniques is provided in accordance with example embodiments.

Many users have become accustomed to viewing shorter and more engaging forms of content, which recently have gained popularity. For example, many users prefer to view short form videos, annotated visual content, and social media posts rather than lengthy articles and other types of long-form text content. In addition, more than 1.5 billion people began using the internet for the first time between 2015 and 2020, and another billion users are expected to begin using the internet between 2020 and 2025. Many of these new users connect to the internet via smartphones and increasingly use voice and video as tools to find information and services online. Further, many internet users are unable to benefit from content that exists in unfamiliar languages, lengthy text content that is difficult to consume on small displays, high resolution content that is difficult or not possible to consume based on computer network or device limitations, content stored in unsupported or incompatible formats, etc.

Many traditional forms of content, such as text content, may present information mostly or entirely in a single way (e.g., primarily, or entirely as long-form text). However, such content may be edited, enhanced, combined, and/or otherwise integrated with one or more other forms of content (e.g., audio content, visual content, augmented reality content, virtual reality content, etc.) to present facts, tell stories, and/or deliver messages to users. Traditional content curation and editing are manual, time-consuming, and expensive processes that require advanced skills and specialized software. As a result, curation and editing usually are not performed on most types of content, including user-generated content, because of the associated complexity and expense. As such, most content, including user generated content, remains unedited when such content otherwise could be improved and enhanced for the benefit of others. Further, this content is often in an old format that is not immersive and is not presented in a manner adapted for current hardware and generations of users. Thus, various users, content owners, content publishers, and others around the world can benefit from the automated generation of immersive interfaces.

The present disclosure provides examples of performing automated generation of immersive interfaces based on transforming and integrating various forms of source content into one or more pieces of new target content to generate immersive interfaces for users. In examples of the present disclosure, a computer system may perform automated generation of immersive interfaces, for example, by analyzing one or more pieces of source content, selecting a plurality of content segments from one or more of the pieces of source content for generating target content, automatically identifying additional content related to each of the content segments for inclusion with respective content segments in the target content, generating the target content based at least in part on combining each respective content segment with the additional content identified for the respective content segment, and providing the target content to a computing device for presentation to a user. In example embodiments, a summarization engine can be trained for specific categories such as discipline, genre, language, and target audience. Content can be generated with multiple outputs with different text depending on summarization engine parameters. Examples may include long-form text, a quick summary, a more detailed summary, a summary plus examples, etc.

One or more immersive interfaces may be generated based on a set of input. By way of example, multiple immersive interfaces may be generated based on the same set of input by varying the parameters to the immersive interface generation pipeline. Example parameters such as summarization parameters, image selection parameters (different corpus), and/or languages, etc. can be varied by varying one or more parameters, multiple user interfaces may be generated from the same set of inputs. As a specific example, consider a multi-sport broadcast event that may include image feeds of different live events. A filtering service can be provided to select appropriate images to generate 70 outputs for different locales (e.g., including 25 languages). After the event, the immersive interface generation system may use a different filtering service and/or different parameters to generate various output from the same content for different requirements or different target audiences.

In some examples, an immersive interface generation system can be used in a variety of different contexts to generate engaging target content based on source content. In some examples, the immersive interface generation system can be provided to a user for use on the user computing device (e.g., distributed as software which can be installed on the user computing device). In this context, a user can provide content to the immersive interface generation system (e.g., by entering text directly or by providing a link to the source content). The immersive interface generation system can generate engaging target content on the user computing device and the user can distribute as desired.

In another example, the immersive interface generation system can be provided as a service to third-party content producers. For example, a content producer (e.g., a particular content producer, a group of content producers, or an entity) can provide content to a platform that includes the immersive interface generation system. In some examples, the provided content can be input to the content platform directly by the content producer. In other examples, the original content can be associated with a link provided by a content producer to the immersive interface generation system. The immersive interface generation system can access the content based on the link and capture the content (e.g., scrape the content from the linked webpage). The provided content can be in a format that is convenient for the content producer, such as a purely textual formatted, formatted as a text article, or unformatted. The immersive interface generation system can process the provided content to produce an engaging target content that includes additional audio and/or visual media not included in the provided content. As noted above, processing the provided content to produce engaging target content can include summarizing the content or extracting one or more key phrases. Processing can include formatting the provided content in accordance with a particular template for display in one or more different display form factors. Additional content (e.g., media content not originally provided) can be identified and added to the target content and translation of the content can be generated.

Once engaging target content has been generated for a particular piece of provided content, the engaging target content can be provided for users to access via that platform that includes the immersive interface generation system. Thus, in some examples, a content platform can include the immersive interface generation system and allow content producers to provide content in a first format (e.g., raw text, article format, and so on) and have engaging target content automatically generated. The engaging target content can be shared with users in one or more new formats and one or more new languages on the content platform.

In another example, a content platform independent of the immersive interface generation system can, using the immersive interface generation system, generate engaging target content for content already published on the content platform. Generating engaging target content can allow the content platform to provide content to users in a more engaging way (e.g., a multimedia presentation), in a plurality of formats (e.g., in a format more appropriate for smartphones), and in additional languages. Making content more engaging and available in additional formats and languages can allow the content platform to provide a more useful service to the users who access its content.

In example embodiments, the immersive interface system can enable tracking of content such as for providing revenue or distributions of revenue. By way of example, the immersive interface system may track content provided to the system by a content provider. The system can convert or otherwise generate an immersive interface based at least in part on content provided by the content provider. The system can track the original content and/or the converted content to enable revenue sharing and/or distribution for example. For instance, the system may track the number of the times the converted content is accessed or otherwise provided to users. Revenue associated with the converted content can be shared between the immersive interface system and the original content provider in example embodiments.

The systems, methods, and computer program products described herein provide a number of technical effects and benefits. As one example, the embodiments described in the present disclosure perform automated analysis and integration of large volumes and different forms of distributed content, and automatically transform and generate new immersive interfaces more efficiently and with fewer computing resources (e.g., less processing power, less memory usage, less power consumption, etc.), that would otherwise be wasted by using manual investigative, creation, editing, and discovery processes.

With reference now to the figures, example aspects of the present disclosure will be discussed in greater detail.

### Example Computing Environment for Automatically Generating Immersive Interfaces

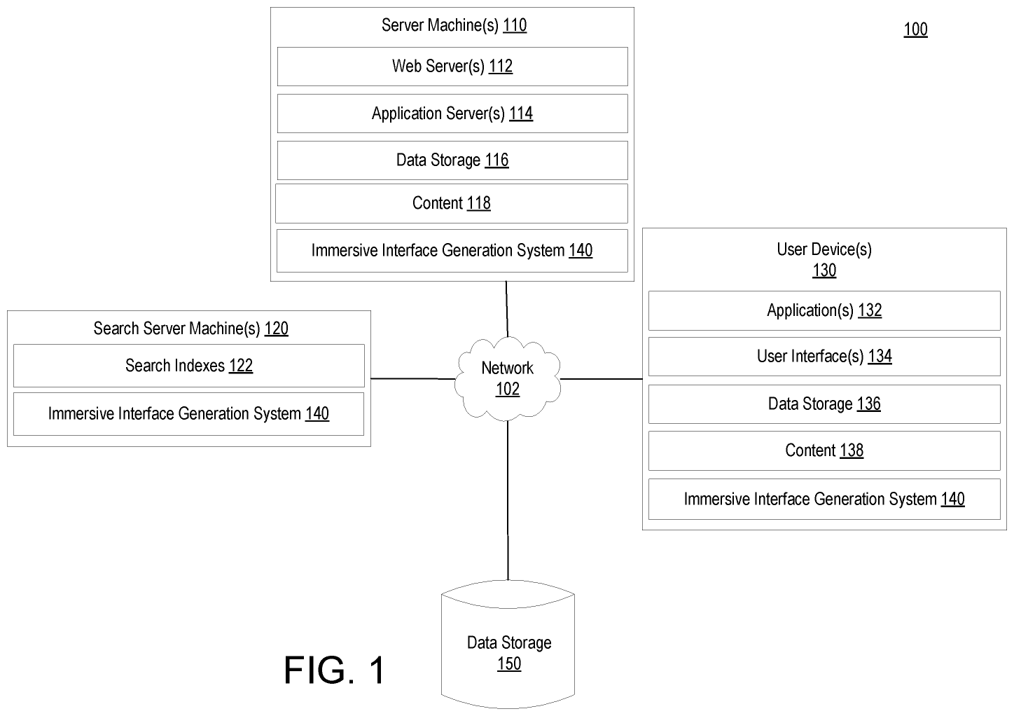

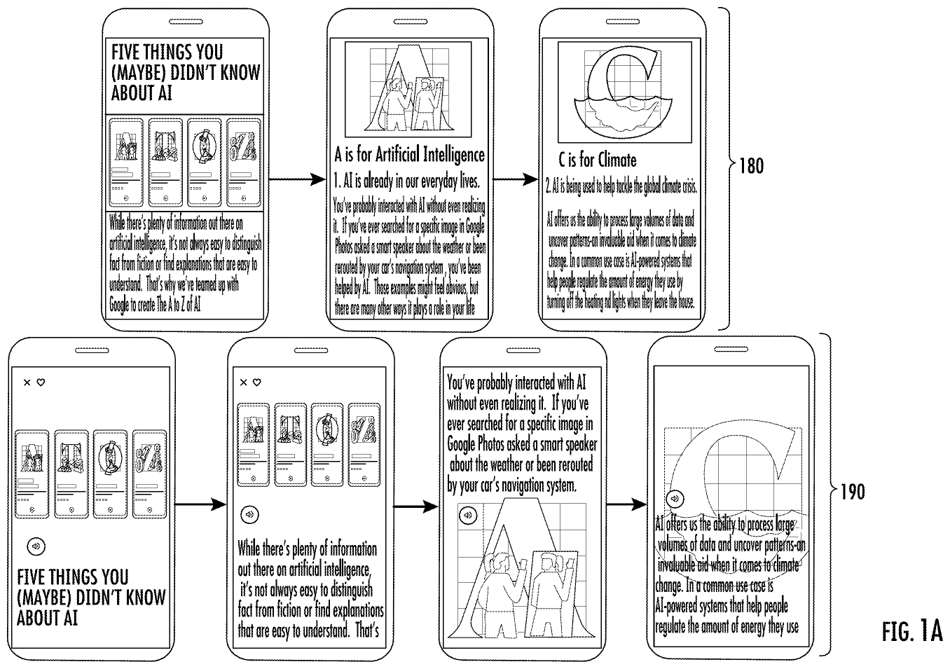

FIG. 1 depicts a block diagram of an example computing environment 100 for performing automated generation of immersive interfaces in accordance with example embodiments of the present disclosure. Example computing environment 100 includes one or more server machine(s) 110, one or more search server machine(s) 120, one or more user device(s) 130, and data storage 150 communicatively coupled over a network 102.

Network 102 may be a public network (e.g., the internet), a private network (e.g., local area network (LAN) or wide area network (WAN)), or any combination thereof. In an example, network 102 may include the internet, one or more intranets, wired networks, wireless networks, and/or other appropriate types of communication networks. Network 102 also may comprise a wireless telecommunications network (e.g., cellular network) adapted to communicate with other communication networks, such as the internet. In addition, network 102 may include one or more short-range wireless networks.

Server machine(s) 110 each may include one or more web server(s) 112 and/or one or more application server(s) 114. Web server(s) 112 may provide text, audio, image, video, or any other content to and from server machine(s) 110 or other sources (e.g., search server machine(s) 120, user device(s) 130, and data storage 150). Web server(s) 112 also may provide web-based application services, business logic, and interfaces to server machine(s) 110, search server machine(s) 120, and user device(s) 130. Web server(s) 112 also may send and receive text, audio, video, image, and/or other content to and from search server machine(s) 120, user device(s) 130, etc. For example, various forms, versions, and types of content (e.g., content 118, 138 and/or content residing in data storage 150, etc.) may be stored for preservation, sharing, and/or the publication.

In an example, one or more web server(s) 112 are coupled to one or more application server(s) 114 that provide application services, data, business logic, and/or APIs to server machine(s) 110, search server machine(s) 120, user device(s) 130, and/or other computing devices (not shown). In some examples, application server(s) 114 provide one or more of such services independently, without use of web server(s) 112. In an example, web server(s) 112 may provide server machine(s) 110, search server machine(s) 120, and user device(s) 130 with access to one or more application server(s) 114 services associated with an automated immersive interface generation system (e.g., immersive interface generation system 140). In an example, such functionality also may be provided as part of one or more different web applications, standalone applications, systems, plug-ins, web browser extensions, and application programming interfaces (APIs), etc. In some examples, plug-ins and extensions generally may be referred to, individually or collectively, as “add-ons.”

In some examples, the one or more web server(s) 112 are coupled to one or more application server(s) 114 can provide a content platform available to users of the user device(s) 130. The immersive interface generation system 140 can produce engaging target content based on content 118 in a first format (e.g., a primarily text-based format). The content platform can host both the original content 118 and the engaging target content. In some examples, the content platform hosts only the engaging generated based on the original content. In some examples, original content provided by content producers is converted into engaging target content by the immersive interface generation system 140. Once the engaging target content is generated it can be made available to users of the content platform and the original content can be discarded.

Server machine(s) 110 include local data storage 116 and may have access to other data storage 150 to store and access various forms of content (e.g., content 118). In an example, server machine(s) 110 may provide, be associated with, or be used in conjunction with one or more cloud or web-based services and applications, such as an internet search engine, a social networking site, a cloud storage provider, a content sharing site, an image or photo sharing site, a video sharing site, a news publication site, enterprise software, and/or any other site, service, or application that stores, processes, adjusts, generates, and/or displays user-provided and/or any other sources or types of content. In various examples, such sites, services, and/or applications may be accessed by users via one or more application(s) 132 running on respective user device(s) 130.

Search server machine(s) 120 generally may be any computer system, device, or other machine capable of receiving, locating, obtaining, retrieving, indexing, and/or searching any form(s) of content. For example, search server machine(s) 120 may discover or otherwise locate content available from any authorized and accessible location including, but not limited to, data storage 150, the internet, intranets, content repositories, content management systems, document management systems, etc. Search server machine(s) 120 also may include one or more web server(s) (not shown) and/or application server(s) (not shown).

In various examples, search server machine(s) 120 may locate and process content by systematically crawling through available content and/or associated metadata. For example, any type of web content or other content may be crawled using hyperlinks, citations, and/or any other references present in source content to identify and locate additional content for analysis, search index generation, and/or other processing.

In various examples, search server machine(s) 120 may analyze various types of content to generate search indexes 122 that facilitate fast and accurate retrieval of relevant content in response to search queries. For example, web crawlers may locate web or other content that is analyzed and used to create search indexes 122 that allow a search engine to quickly identify and retrieve relevant content for a search query submitted via user device(s) 130. In some examples, search server machine(s) 120 may store or maintain search indexes 122 locally and/or reference search indices of other services that are generated and/or stored elsewhere. Also, search server machine(s) 120 may cache various forms of content, for example, for use in association with analyzing content, generating search indexes 122, retrieving search results in response to search queries, etc. In various examples, such cached information may be stored locally on search server machine(s) 120, in data storage 150, and/or other locations accessible to search server machine(s) 120.

In various examples, search server machine(s) 120 may receive and process search queries received from user device(s) 130. Search queries may include, but are not limited to, informational queries relating to a particular topic, navigational queries seeking a particular website or webpage of a party, transactional queries reflecting user interest in performing a specific activity like cooking a particular meal, mending torn fabric, fixing a flat tire, and/or generally any other type of search query. Search server machine(s) 120 generally may receive one or more types of search queries via a search interface associated with user device(s) 130, application(s) 132, user interface(s) 134, etc. For example, search server machine(s) 120 generally may receive and process search queries submitted as text, audio, spoken words, and/or visual information (e.g., visual content such as a photo or other image, a video segment, etc.).

In various examples, search server machine(s) 120 may process search queries by accessing and searching one or more search indexes 122 based on a search query to quickly identify and return relevant search results. Search indexes 122 generally refer to any index data structure used by computer systems, devices, or software applications to provide fast and accurate retrieval of information, for example, in response to search queries. Examples of search indexes 122 generally may include, but are not limited to, inverted indexes, b-tree indexes, bitmap indexes, n-gram indexes, etc. In various examples, search server machine(s) 120 identify and return relevant search results to user device(s) 130, application(s) 132, and/or user interface(s) 134 in response to search queries (e.g., internet search engine queries).

User device(s) 130 generally may be a personal computer (PC), laptop, mobile phone, tablet computer, server computer, wearable computing device, or any other type of computing device (i.e., a client machine). User device(s) 130 may run an operating system (OS) that manages hardware and software of a respective device. A browser application (not shown) may run on user device(s) 130. The browser application may be a web browser that can access content and services provided by server machine(s) 110, search server machine(s) 120, or a combination of server machine(s) 110 and/or, search server machine(s) 120. Other types of computer programs and scripts also may run on user device(s) 130.

User device(s) 130 may include one or more application(s) 132, user interface(s) 134, data storage 136, and content 138. User device(s) 130 generally may execute or run one or more application(s) 132 or client components or versions of application(s) 132 that interoperate with one or more server machine(s) 110 and/or one or more search server machine(s) 120. For example, application(s) 132 may include or provide access to one or more immersive interface generation system 140 and services running locally and/or remotely.

Application(s) 132 each generally may provide user interface(s) 134 that allow a user to submit user input (e.g., commands, instructions, search queries, etc.) and to receive various text, graphics, and/or audio output in association with respective application(s) 132 running on user device(s) 130. For example, a user generally may provide user input to application(s) 132 via user input components of respective user device(s) 130, such as a touch-sensitive component (e.g., a touch-sensitive display screen or a touch pad) that is sensitive to the touch of a user input object (e.g., a finger or a stylus), a virtual keyboard, a traditional keyboard, a mouse, a microphone, a traditional keyboard, or by other means in which a user can provide input to application(s) 132 via a device. A user also may receive output from application(s) 132 via one or more user interface(s) 134 provided via a display, user device(s) 130, computing system, and/or any other type of device.

Application(s) 132 may include, for example, web browser, content management, document management, search engine, map, navigation, social networking, photo sharing, video sharing, storage service, digital wallet, mobile wallet, and/or any other type(s) of “apps” that run on user device(s) 130. Further, application(s) 132 may have corresponding web sites, services, and/or APIs that may be used in association with, or separate and apart from application(s) 132. In some examples, the applications 132 can include an immersive interface generation system 140 that allows the user to generate engaging target content on the user device 130 based on content provided by the user. In some examples, the user can provide text directly (e.g., input the text into the immersive interface generation system 140). In other examples, the user can identify a source of content (e.g., based on a weblink) that the immersive interface generation system 140 can scrape for source content. Data storage 136 generally may include any removable or non-removable storage device(s) associated with user device(s) 130, which also may have access to other various storage (e.g., data storage 150) via network 102.

In an example, server machine(s) 110, search server machine(s) 120, user device(s) 130, and/or other computing devices each may store and access various forms of content 118, 138 (e.g., source content, target content), including content from data storage 150, and/or elsewhere. In an example, content generally may refer to any text data, audio data, visual data, graphical data, animations, images, videos, multimedia, augmented reality data, virtual reality data, and/or any other data used to represent or describe various forms or formats of any type of content of any dimension (e.g., 2D, 3D, etc.). In various examples, content may be raw or newly captured, preprocessed or partially edited, professionally edited, curated, user generated, and/in any other form.

Content may include any type of text content. Text content generally refers to any content that comprises letters, numbers, words, phrases, sentences, paragraphs, etc. Text content may include titles, notes, messages, web pages, articles, stories, books, and or any other type of written or printed works in digital and/or any other format. In various examples, text content may be long-form text content that is comprised primarily or entirely of text.

Content also may include any type of audio content. Audio content generally refers to any sound including but not limited to voice, audible sound, inaudible sound, sound effects, sound clips, background or other types of music, voice-over audio, text-to-speech audio, etc. Audio generally may be presented individually and/or in combination with other forms and types of content.

Content also may include any type of visual content such as images, still graphics, animated graphics, video, etc. Images generally may include any visual or graphical representation such as photographs or screenshots that are captured by a camera, computing device, and/or other device. Images may include, for example, portrait, square, panoramic, and/or any other types of images. Visual content also may include, for example, one or more segments or pieces of original and/or edited content such as a burst of photographs, video clips, movie trailers, montages, music videos, highlight reel videos, advertisement videos, etc.

Video content generally refers to a set of sequential image frames representing a scene in motion. For example, a series of sequential images may be captured continuously or, later reconstructed to produce the effect of a moving picture, which may include camera motion and/or motion of contents within a scene. Video content may be presented in various formats including, but not limited to, analog, digital, two-dimensional video, and three-dimensional video. Further, video content may include movies, video clips, or any set of animated images to be displayed in sequence. Video data may include digital videos having a sequence of static image frames that also may be stored as image data. Further, each image frame may represent a snapshot of a scene that has been captured according to a time interval.

Data storage 150 generally refers to persistent storage capable of preserving various types of content, such as text, audio, images, video, and graphics. In some examples, data storage 150 may include a network-attached file server or cloud storage, while in other examples, data storage 150 may include other forms of persistent storage such as an object-oriented database, a relational database, and so forth. In some examples, data storage may include one or more content repositories that store digital content and may provide services such as data organization, data management, versioning, data retention policies, indexing, search, retrieval, etc. For example, content repositories may include one or more content management systems and/or document management systems controlled, operated, and/or provided by one or more different parties.

In various examples, data storage 150 may include user generated content (e.g., user generated documents, images, videos, etc.) uploaded by users via user device(s) 130 and/or content provided by one or more other parties. Data may be added to data storage 150, for example, as discrete files (e.g., structured text documents, unstructured text documents, HTML files, XML files, spreadsheet files, database files, multimedia files, motion picture experts group (MPEG) files, windows media video (WMV) files, joint photographic experts group (JPEG) files, graphics interchange format (GIF) files, portable network graphics (PNG) files, etc.), or as components of a single compressed file (e.g., a zip file).

In various examples, server machine(s) 110, search server machine(s) 120, and/or user device(s) 130 run, execute, or otherwise utilize immersive interface generation system 140. For example, user device(s) 130 may include one or more application(s) 132 associated with a service (e.g., immersive interface generation system 140) provided by one or more server machine(s) 110 and/or search server machine(s) 120. For example, various types of computing devices (e.g., smart phones, smart televisions, tablet computers, smart wearable devices, smart home computer systems, smart assistant devices, etc.) may use specialized apps and/or APIs to access services provided by server machine(s) 110 and/or search server machine(s) 120, to issue commands to server machine(s) 110 and/or search server machine(s) 120, and/or to receive content from server machine(s) 110 and/or search server machine(s) 120 without visiting or using web pages.

In an example, functions performed by one or more of server machine(s) 110 and/or search server machine(s) 120 may be performed by one or more other machine(s) and/or user device(s) 130, in whole or in part. Server machine(s) 110 and/or search server machine(s) 120 may be accessed as a service provided by systems or devices via appropriate application programming interfaces (APIs) and data feeds, and thus are not limited to use with websites. Further, server machine(s) 110, search server machine(s) 120 and/or user device(s) 130 may be associated with and/or utilize one or more immersive interface generation system 140 services, for example, offered or provided by one or more different parties.

In various examples, immersive interface generation system 140 performs automatic generation of immersive interfaces by automatically transforming source content into engaging target content comprising a combination of at least three or more of text, audio, still images, animated images, graphics, video, interactive user interface elements, etc. In examples of the present disclosure, immersive interface generation system 140 generates immersive interfaces automatically using a rigorous computerized process that rapidly transforms basic source content existing primarily or entirely in one form into dynamic and engaging user interfaces in ways not previously performed.

In an example, immersive interface generation system 140 generates one or more immersive interfaces associated with a particular topic, subject, person, category, activity, article, recipe, news event, sporting event, etc. One or more immersive interfaces may be generated from one or more sources and may be generated in a variety of formats. Such immersive interfaces may be generated, for example, at different points in time. For example, one or more immersive interfaces may be generated in advance or anticipation of a user request, in response to or based on one or more user requests or events, partially prior to a user request with additional generation, modification, and/or transformation being performed based on various attributes associated with a user request (e.g., user preferences, physical computing device capabilities, operating system, network settings, application features and settings, location, language, etc.).

In an example, immersive interface generation system 140 generates one or more immersive interfaces in response to a search query submitted by a user. For example, immersive interface generation system 140 may automatically generate one or more immersive interfaces based on one or more of audio, visual, text, and/or other input or information associated with a search query. In various examples, one or more generated immersive interfaces may be transmitted or otherwise provided to a computing device in response to a search query. In various examples, generated immersive interfaces may be stored and cached for use and reuse and later provided to one or more other computing devices in response to other search queries of users (e.g., similar, related, and/or exact search queries.

In an example, immersive interface generation system 140 determines one or more pieces of source content to analyze based on a request. A request generally may refer to a search query, instruction, command, or any other type of input or request received from a user and/or machine. In some examples, a request may include source content to be analyzed, information identifying source content to be analyzed, information that allows immersive interface generation system 140 to locate and/or identify one or more pieces of source content to be analyzed, etc. For example, a request may include one or more general or particular locations of source content in data storage (e.g., data storage 116, 136, 150) and/or any type of content repositories. A request also may include information about attributes of source content or one or more other criteria that allow immersive interface generation system 140 to identify or otherwise determine source content that is to be analyzed for generating immersive interfaces.

In an example, immersive interface generation system 140 analyzes text, audio, and/or visual content associated with a request, such as input associated with a search query to determine source content. Immersive interface generation system 140 also may analyze organization and structure of words, phrases, or other information associated with a request to determine one or more pieces of source content to analyze in association with the request. In some examples, immersive interface generation system 140 may determine one or more pieces of source content to analyze based on one or more results returned from search server machine(s) 120 in response to a search query.

In an example, immersive interface generation system 140 analyzes one or more pieces of source content based on a request. For example, one or more pieces of structured and/or unstructured content may be analyzed to identify candidate content segments for generating immersive interfaces. In some examples, immersive interface generation system 140 analyzes different pieces of source content (e.g., files) and selects one or more portions of source content from each of one or more pieces of the source content. For example, one or more sentences may be selected from different source content files, (web pages, articles, books, etc.) and organized into a logically flowing outline, summary, story, message, and/or any other form or type of content.

In an example, immersive interface generation system 140 analyzes each selected content segment and, for each of the selected content segments, assigns respective weights to each of one or more objects, activities, and/or relationships present in a respective content segment, for example, to assist in identifying additional relevant content that may be combined with or otherwise included with the respective selected content segment in an immersive interface. For example, text or other information may be extracted from each selected content segment and analyzed to identify entities, activities, and/or relationships in each particular selected content segment and to assign a weighting to each of one or more of the entities, activities, and/or relationships represented in the particular content segment. Content may be extracted from any type of content including text, image, and video. For example, OCR can be performed on one or more images or people/object recognition can be performed over the images. Further, multiple content sources can be used to generate immersive interfaces. For instance, text may be extracted from one source and images from another, etc. People, objects, animals, scenes, locations, landmarks, activities, and/or other types of types of information may be determined based on analyzing text, audio, visual, and/or other forms of selected content segments. In various examples, each of one or more entities, activities, and/or relationships in a particular content segment may be weighted, for example, based on one or more of organization, ordering, position, prominence, duration, associations, interactions, and/or any other aspects of information determined based on analyzing the selected content segments.

Immersive interfaces may be generated based on one or more sets of input. For instance, multiple immersive interfaces may be generated based on the same set of input by varying the parameters to the immersive interface generation pipeline. Example parameters such as summarization parameters, image selection parameters (different corpus), and/or languages, etc. can be varied by varying one or more parameters, multiple user interfaces may be generated from the same set of inputs. As a specific example, consider a multi-sport broadcast event that may include image feeds of different live events. A filtering service can be provided to select appropriate images to generate 70 outputs for different locales (e.g., including 25 languages). After the event, the immersive interface generation system may use a different filtering service and/or different parameters to generate various output from the same content for different requirements or different target audiences.

In an example, immersive interface generation system 140 identifies additional content related to each selected content segment to include with respective content segments in an immersive user interface. For example, immersive interface generation system 140 may separately query or otherwise search one or more collections of additional content to identify one or more pieces of additional content that correspond with, are related to, or otherwise match each selected content segment. For example, immersive interface generation system 140 may analyze, score, and rank various pieces of additional content located in data storage 150 or other locations based on weightings determined respectively for each of one or more entities, activities, and/or relationships in a particular selected content segment.

In an example, immersive interface generation system 140 determines one or more pieces of additional content to combine with each content segment based on scoring and/or ranking separate pieces of additional content according to similarity with each selected content segment. For example, immersive interface generation system 140 may select one or more pieces and/or types of additional content that relate to a particular content segment. In some examples, immersive interface generation system 140 scores or scores and ranks additional visual content and/or additional audio content in view of weightings assigned to each of one or more entities, activities, and/or relationships identified in text-based selected source content. As such, immersive interface generation system 140 may identify, select, and obtain additional content of one or more different types that correspond to each piece of selected content to automatically generate an immersive interface that combines the respective pieces of selected source content (e.g., of one content type) with the corresponding additional content (e.g., of one or more additional content types).

In an example, immersive interface generation system 140 automatically generates one or more pieces of target content for an immersive user interface. One or more immersive interfaces may be generated from one or more sources and may be generated in a variety of formats. For example, immersive interface generation system 140 may merge, blend, or otherwise combine each particular selected content segment with its corresponding additional content to generate one or more associated types of target content. Such types of target content may include but are not limited to one or more timed or untimed display slides, multimedia slides, multimedia clips, and/or any other types of target content that may be included as part of an immersive user interface. In various examples, immersive interface generation system 140 processes each of a plurality of selected text content segments by combining each particular content segment with its corresponding additional visual content and corresponding additional audio content to generate an immersive user interface.

In an example, immersive interface generation system 140 automatically generates a piece of target content for each of multiple selected content segments based at least in part on combining each selected content segment with additional content of at least two or more additional content types. In some examples, immersive interface generation system 140 generates a piece of target content based on combining text from a selected content segment with additional audio content and additional visual content corresponding to the text from the selected content segment.

As an example, and for illustrative purpose only, FIG. TA depicts example illustrations showing an example of source content and an example of immersive interfaces 190 automatically generated from the example source content in accordance with example embodiments of the present disclosure. For example, illustrations of example source content 180 generally show an example of source content as manually scrolled on a display of a mobile device. Illustrations of example immersive interfaces 190 generally show an example of immersive interfaces generated from the example of source content 180. In an example, such immersive interfaces generally may be presented automatically and without interruption. As such, a user generally may view and listen to various enhanced information provided via a series of generated immersive interfaces without performing repetitive and/or non-repetitive interactions.

In an example, immersive interface generation system 140 automatically generates an immersive user interface by integrating multiple generated pieces of target content together. In some examples, a collection of two or more pieces of target content may be integrated together into an immersive user interface, such as a collection of display slides, multimedia slides, multimedia clips, and/or in other forms or arrangements as new content. In various examples, an immersive user interface may include any one or more of animation, automated user interface progression, transitions between different pieces of integrated content, etc. In various examples, immersive interface generation system 140 may generate a set of immersive display slides, multimedia slides, or multimedia clips for a user interface, such as a tile user interface or an interactive story page with automated, seamless user interface progression that flows cohesively at a configured or predefined pace. In some examples, immersive interface generation system 140 generates an immersive user interface as part of a standardized file, set of files, or package that can be utilized with one or more different types of user interfaces and/or user interface controls (e.g., an animated tile user interface control, storyboard user interface control, augmented reality user interfaces, virtual reality interfaces, and/or other any other type of user interfaces or user interface controls capable of providing immersive interfaces to users). In various examples, immersive interface generation system 140 generates immersive interfaces that are automatically presented to users, allowing any user to view and understand the information being presented without prior experience, knowledge, or training.

In an example, immersive interface generation system 140 provides automatically generated immersive interfaces to one or more computing devices for presentation, display, communication, or any other type of delivery to one or more users. In various examples, automatically generated immersive interfaces may be provided to users via user device(s) 130. For example, immersive interface generation system 140 may provide one or more generated immersive interfaces in response to a search query or other types of user requests submitted to server machine(s) 110 and/or search server machine(s) 120. In various examples, immersive interface generation system 140 provides generated immersive interfaces in one or more forms including, but not limited to, as an animated tile in a tile-based user interface, as content in a feed, as a post in a social media feed or on a social media site, as carousel user interface or post, as a set of story pages, and/or generally as part of any other type of user interface or in various other forms of presentation. In some examples, immersive interfaces may be generated in a web story format that blends audio, video, image, animation, and/or text that conveys a dynamic, immersive experience to users in contrast to one or more long-form text documents.

In various examples, immersive interface generation system 140 allows users to automatically generate immersive interfaces from one or more types of available content. For example, any type of application, website, system, and/or service associated with immersive interface generation system 140 generally may allow individual users such as influencers, content owners, content providers, content partners, content licensees, or any type of entity to automatically generate high-quality immersive users interfaces quickly and without specialized software applications or skills. In some examples, any number of users or entities (1, 10, hundreds, thousands, millions, etc.) each may use immersive interface generation system 140 to automatically generate immersive interfaces using their own content, shared content, licensed content, public domain content, and/or any other sources of permitted content. Users then may share and/or publish generated immersive interfaces with others, for example, via the web, social media, content sharing sites, etc.

In example embodiments, the system may receive feedback from users and incorporate the feedback into generated content. An application tool can be provided to publishers that enables the publisher to make edits to the generated content. Further, the system may analyze consumer behavior on generated content and refine the engine to modify the content to make it more user friendly and useful. In some examples, advertising units may be programmatically added into the generated content Further, analytics can be programmatically added into the generated content. Such analytics may enable tracking, measurement, feedback loop generation and engine plus output refinement.

### Example Methods for Performing Automatic Generation of Immersive Interfaces

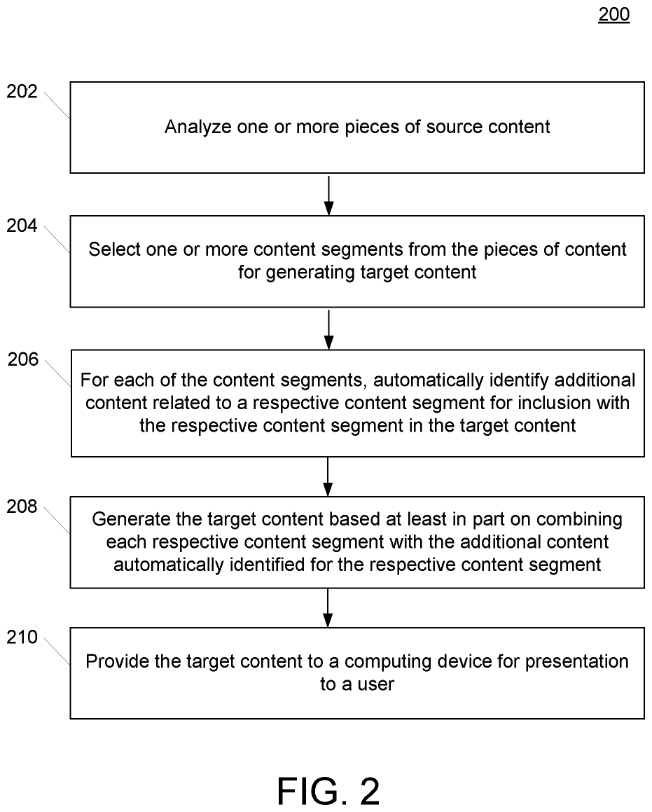

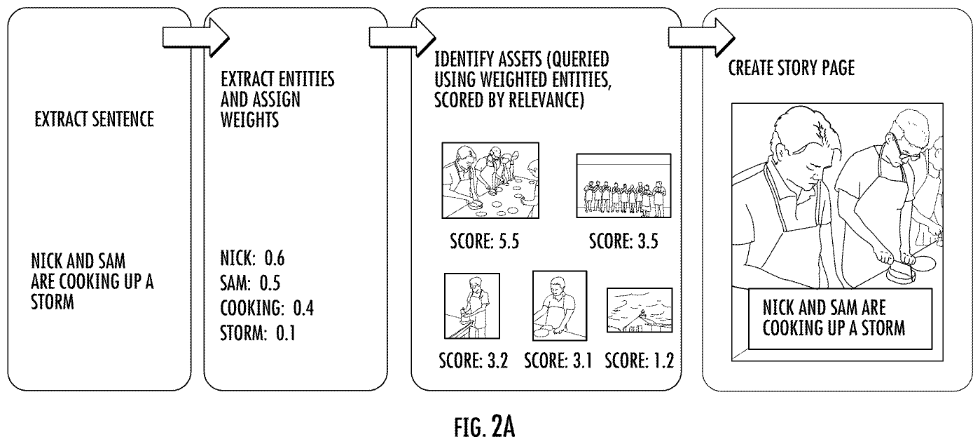

FIG. 2 depicts a flow diagram of an example method 200 for performing automatic generation of immersive interfaces in accordance with example embodiments of the present disclosure. Method 200 and the other processes described herein are shown as sets of blocks that specify operations performed but are not necessarily limited to the order or combinations shown for performing the operations by the respective blocks. As such, one or more of the various portions of the method 200 can be omitted, rearranged, combined, and/or adapted in various ways without deviating from the scope of the present disclosure.

One or more portions of method 200, and the other processes described herein, can be implemented by one or more computing devices such as, for example, one or more computing devices of a computing environment, for example, as illustrated in example computing environment 100 of FIG. 1 (e.g., one or more of server machine(s) 110, search server machine(s) 120, user device(s) 130, etc.). While portions of the following discussion may be made to a particular computing environment, such reference is made for example only. The operations are not limited to performance by one entity or multiple entities operating on one device or in any particular computing environment. As such, any one or more portions of these processes can be implemented as operations on the hardware components of the devices described herein.

At (202), a computing system analyzes one or more pieces of source content. In an example, immersive interface generation system 140 analyzes one or more pieces of source content associated with one or more items that may include, but are not limited to, a particular topic, subject, person, category, activity, article, recipe, news event, sporting event, etc. For example, immersive interface generation system 140 may receive a request, such as a user search query or request to generate an immersive interface. In various examples, such requests and other types of requests generally may include information that names, describes, is associated with, or that otherwise directly or indirectly identifies information that may be used to obtain one or more pieces of source content to generate an immersive user interface.

In an example, immersive interface generation system 140 receives a request pertaining to a topic, such as malaria, which is a mosquito-borne infectious disease that affects humans and animals in various regions of the world. The request may comprise or be associated with text, audio, and/or visual content. For example, the request may be a text search query, voice search query, image query, or visual content that includes the word “malaria” or a phrase that includes the word “malaria” (e.g., such as “what is malaria”, “symptoms of malaria”, “prevent malaria” etc.). In other examples, the request may be a request from a content provider or other entity (e.g., a medical provider, a national public health agency, a medical journal, a publisher, or any other type of entity) to generate one or more immersive interfaces pertaining to “malaria” or any other type of item(s). In various examples, source content may be searched, located, and identified in data storage 116, 136, 150, databases, data repositories, content management systems, document management systems, across one or more networks 102 such as an intranet or the internet, and/or anywhere else content or associated metadata resides to identify relevant source content.

In an example, immersive interface generation system 140 of the computing system identifies and obtains one or more pieces of source content to use for generating one or more immersive interfaces. In some examples, one or more pieces of identified source content may be translated into a standard language for analysis. In various examples, one or more identified pieces of source content each may be analyzed to determine one or more relevant segments, areas, sections, subsections, words, phrases, sentences, paragraphs, pages, and/or any other identifiable or other relevant portions of such pieces of source content for use in generating immersive interfaces.

As an example, and for illustrative purposes only, FIG. 2A illustrates a non-limiting example of performing automatic generation of an immersive interface in accordance with example embodiments of the present disclosure. For example, such an example may be used as part of processing each of multiple different pieces of source content to generate a plurality of corresponding pieces of immersive interfaces that are provided to a computing device for presentation to a user.

At (204), a computing system selects one or more content segments from the one or more pieces of source content for generating target content. In an example, immersive interface generation system 140 selects one or more content segments from each of one or more pieces of source content for use in generating an immersive interface. For example, immersive interface generation system 140 may select one or more words, phrases, sentences, paragraphs, sections, and/or any other subset of content from each of one or more documents, such as long-form text documents, based on analyzing various source content in view of a request.

In an example, immersive interface generation system 140 analyzes one or more pieces of source content and determines one or more portions from each of one or more of the source documents to use in generating an immersive user interface. For example, immersive interface generation system 140 may identify and select multiple different portions of a single piece of source content (e.g., a licensed Wikipedia® article, licensed or owned web content, and/or other example permissible use of source content) or may identify and select one or more different portions from each of multiple different pieces of source content for generating an immersive user interface. In some examples, immersive interface generation system 140 processes pieces of selected source content, which for example may include, consolidating, summarizing, ordering, reordering, and/or by performing any other procedures involving the pieces of selected source content in preparation for generating an immersive interface. In some examples, rather than exact sentences from source text, the system may refine and/or recreate text to summarize the content.

In an example, immersive interface generation system 140 identifies and obtains one or more different pieces of source content associated with an item (e.g., people, objects, animals, scenes, locations, landmarks, activities, and/or other types of types of information) from each of one or more pieces of source content. In some examples, immersive interface generation system 140 may summarize each of one or more pieces of selected source content into one or more phrases or sentences pertaining to the main point of a piece of source content. In some examples, immersive interface generation system 140 summarizes each of one or more pieces of source content into one, two, or three, or any number of phrases and/or sentences. In various examples, immersive interface generation system 140 may separate and organize different original and/or summarized pieces of source content into a series of logically flowing phrases or sentences selected for generating an immersive interface. Also, in various examples, immersive interface generation system 140 may perform translation on any one or more of such phrases and/or sentences, so that the phrases and/or sentences are represented in a standard or common language.

In various examples, immersive interface generation system 140 analyzes each of one or more pieces of selected source content and identifies, for example, one or more entities, activities, and/or relationships in each particular selected content segment and assigns a weighting to each of one or more of the entities, activities, and/or relationships represented in the particular content segment. For example, people, objects, animals, scenes, locations, landmarks, activities, and/or other types of types of information may be determined based on analyzing text, audio, visual, and/or other forms of selected content segments. In various examples, each of one or more entities, activities, and/or relationships in a particular content segment may be weighted, for example, based on one or more of organization, ordering, position, prominence, duration, associations, interactions, and/or any other aspects of information ascertained from analyzing the selected content segments.

As an example, immersive interface generation system 140 may analyze a selected content segment, such as “Nick and Sam are cooking up a storm.” Immersive interface generation system 140 then may identify entities, activities, and/or relationships based on analyzing the example selected content segment. For example, identified entities, activities, and/or relationships for the example selected content segment may include “Nick,” “Sam,” “cooking,” and “storm.” Immersive interface generation system 140 also may assign weights to each of the identified entities, activities, and/or relationships in the example selected content segment. In one example, assigned weights for the example content segment may include “Nick” (0.6), “Sam” (0.5), “cooking” (0.4), and “storm” (0.1). In various examples, subject matter in selected content segments and associated weightings may be analyzed, identified, and weighted based on organization and order of information in a selected content segment. In various examples, subject matter in selected content segments also may be analyzed, identified, and weighted in view of associated information obtained from a knowledge graph, knowledgebase, or any other type of system(s) or data structure(s) that, for example, provide information about entities, objects, events, relationships, situations, etc. In various examples, immersive interface generation system 140 may utilize identified subject matter and associated weightings of such identified subject matter found in selected content segments to automatically identify additional corresponding content to combine with such selected content segments for generating immersive interfaces.

At (206), immersive interface generation system 140 automatically identifies additional content to include with each of the respective content segments in the target content. In an example, immersive interface generation system 140 processes each of one or more selected pieces of source content to identify, compare, and select one or more pieces of additional content to combine with each respective piece of source content in an immersive interface. For example, immersive interface generation system 140 may search for, locate, obtain, score, rank, compare, evaluate, and/or perform various other processing to identify corresponding (e.g., relevant, highly relevant, and/or the most relevant) additional content to include with each of one or more pieces of source content in an immersive interface.

In an example, immersive interface generation system 140 identifies entities, activities, relationships, and/or other concepts present in or otherwise associated with a piece of selected source content. Immersive interface generation system 140 then may extract and assign weights to each of one or more of such identified entities, activities, relationships and/or other concepts in each of one or more different pieces of selected source content. In various examples, immersive interface generation system 140 uses information associated with the identified entities, activities, relationships and/or other concepts, to query, search for, locate, obtain, score, rank, compare, evaluate, and/or perform various other processing to identify additional content compatible, relevant, or otherwise corresponding to each particular piece of selected source content. In various examples, immersive interface generation system 140 accesses additional content from any authorized and permissible location, for example, such as data storage 116, 136, 150 and/or elsewhere including, but not limited to, the internet, intranets, content repositories, content management systems, document management systems, etc.

In various examples, immersive interface generation system 140 determines additional content to analyze based on one or more license management software applications and/or systems. License management software applications and systems generally refer to any tool that allows users or organizations to track, manage, and/or obtain information about license status, license agreements, license terms, license rules, and license compliance associated with various types of assets including, but not limited to, content, third-party content, partner content, public domain content, any other type of content, software applications, hardware, technology, etc. In some examples, license management software applications and systems may include notice information, attribution information, and/or any other type of information that immersive interface generation system 140 may include, for example, with additional content used in an immersive interface.

In various examples, immersive interface generation system 140 obtains and analyzes one or more pieces of additional content to determine additional content that will be matched and combined with a particular piece of selected source content in an immersive interface. For example, immersive interface generation system 140 may obtain additional content in any form or type, such as images, videos, audio, and text based on weightings associated with entities, activities, relationships and/or other concepts identified in a piece of selected source content. Immersive interface generation system 140 then may analyze additional content and determine a relevance score based on weightings associated with entities, activities, relationships and/or other concepts identified in a piece of selected source content.

In various examples, immersive interface generation system 140 analyzes and scores pieces of additional content, such as images, videos, audio, and text based on how closely each of the pieces of additional content correspond to or otherwise match the selected source content. For example, immersive interface generation system 140 may perform any type of visual, audio, or textual analysis to score any piece of additional content. In some examples, immersive interface generation system 140 analyzes visual content using image segmentation, image classification, object detection, image recognition, object recognition, and/or any other type of analysis on additional content that is visual (e.g., images, videos, multimedia content with visual components, etc.). In some examples, immersive interface generation system 140 analyzes audio content to detect, recognize, interpret, identify or various types of sound, voices, noises, interactions, and/or any other aspects of additional content associated with audio (e.g., sound recordings, sound clips, sound associated with multimedia such as video, etc.). In some examples, immersive interface generation system 140 analyzes text, for example, using text processing, natural language processing, and/or any other type of processing to identify various aspects of additional content associated with text. Content may be extracted from any type of content including text, image, and video. For example, OCR can be performed on one or more images or people/object recognition can be performed over the images.

In one example, where a piece of selected source content is “Nick and Sam are cooking up a storm,” immersive interface generation system 140 may search authorized additional content based on identified concepts and weightings of the selected source content. For example, immersive interface generation system 140 may use concepts and weightings determined based on natural language processing, analyzing a knowledge graph, and/or in one or more other ways. For instance, in the present example, such concepts and weightings may be “Nick” (0.6), “Sam” (0.5), “cooking” (0.4), and “storm” (0.1). As such, immersive interface generation system 140 may analyze and rank various additional content based on such concepts and weightings. For instance, an additional content, such as an image with Nick and Sam may be scored higher than additional content only including one of Nick or Sam. In addition, content that includes Nick and Sam in a kitchen may be scored higher than Nick and Sam walking outdoors. Further, additional content of Nick and Sam cooking in a kitchen may be scored and ranked highest among the mentioned examples based on being the closest match to the selected source content.

In an example, immersive interface generation system 140 selects one or more pieces of additional content for each piece of selected source content. For example, immersive interface generation system 140 may select one or more pieces of additional content based on scoring, ranking, or otherwise evaluating attributes of additional content compared to attributes of selected source content. In some examples, immersive interface generation system 140 selects one or more pieces of additional visual content, such as one or more photos, images, video segments, etc. Immersive interface generation system 140 also may select one or more pieces of additional audio content and/or additional text content to combine with selected source content for generating an immersive interface.

In some examples, immersive interface generation system 140 selects additional audio content based on text-to-speech (TTS) audio generated from source content. For example, immersive interface generation system 140 may generate text-to-speech content or a voice-over associated with a particular language, region, dialect, locale, genre, licensed character, licensed voice, user preference, etc. In various examples, additional audio content is not limited to text-to-speech and may include any one or more various types of audio including, but not limited to, background music, sound clips, sound effects, actual voice narration, text-to-speech audio and/or other types of audio content that may be presented individually and/or together with selected source content in an immersive user interface.

At (208), immersive interface generation system 140 generates the target content based, at least in part, on combining each respective content segment with corresponding, identified additional content. In an example, immersive interface generation system 140 automatically generates one or more pieces of target content for an immersive user interface. For example, immersive interface generation system 140 may automatically combine, merge, blend, edit, curate, arrange, size, resize, and/or otherwise generate a new piece of target content for an immersive interface from a selected content segment and the corresponding additional content identified for the selected content segment. In some examples, a generated piece of target content may include, but is not limited to, one or more timed or untimed display slides, multimedia slides, multimedia clips, and/or any other forms or types of target content that may be included as part of an immersive user interface.

In various examples, immersive interface generation system 140 processes a selected content segment of a single content type (e.g., one of text, audio, or visual content) and automatically generates target content for an immersive interface comprising, two, three, four, and/or any number of additional content types (e.g., text, audio, visual, augmented reality, virtual reality, etc.). In one example, immersive interface generation system 140 may generate a new piece of immersive target content from source content of a single type automatically by editing, arranging, and/or combining a selected segment of the source content with corresponding additional visual content and corresponding additional audio content to generate target content comprising at least three types of content for an immersive user interface. For example, selected source content comprising text such as “Nick and Sam are cooking up a storm” may be automatically combined with additional visual content comprising both Nick and Sam cooking together in a kitchen into a piece of target content. In addition, automatically generated text-to-speech of selected source content text and/or any other additional audible content (e.g., cooking sounds, sound of Nick and Sam talking about cooking, etc.) also may be combined together for an immersive interface.

In various examples, immersive interface generation system 140 automatically integrates multiple generated pieces of target content together into an immersive user interface. For example, a collection of two or more pieces of automatically generated target content may be integrated together into an immersive user interface comprising multiple different content types (text, audio, video, etc.). In some examples, immersive interface generation system 140 may generate a set of immersive display slides, multimedia slides, or multimedia clips for a user interface, such as a tile user interface or an interactive story page, with automated, seamless user interface progression that flows cohesively along on a configured or predefined pace, for example, without user interaction. As such, in some examples, immersive interface generation system 140 may automatically transform lengthy passages of long-form text are difficult to understand, navigate, and require repeated scrolling or other user interaction (e.g., on various types of mobile devices) into a new, audio-visual, and immersive form for new internet users and other users of any skill level. In some examples, immersive interface generation system 140 also may automatically transform video content (e.g., original, lengthy, etc.) into summarizations presented via immersive content. Further, immersive interface generation system 140 may be used to transform large, existing corpuses of non-visual content into immersive interfaces.

At (210), immersive interface generation system 140 provides the generated target content to a computing device for presentation to a user. In an example, immersive interface generation system 140 transmits automatically generated immersive interfaces to one or more computing devices for presentation, display, communication, to one or more users. In some examples, immersive interface generation system 140 may provide one or more generated immersive interfaces to user device(s) 130 in response to a search query or any other type of user request. Generated immersive interfaces may be provided in one or more forms including, but not limited to, as an animated tile in a tile-based user interface, as content in a feed, as a post in a social media feed or on a social media site, as carousel user interface or post, as a set of story pages, and/or generally as part of any other type of user interface or in various other forms for presentation. In some examples, immersive interfaces may be provided as accelerated mobile pages and/or in a web story format that blends various audio, video, image, graphics, animation, and/or text to provide a dynamic, immersive experience to users.

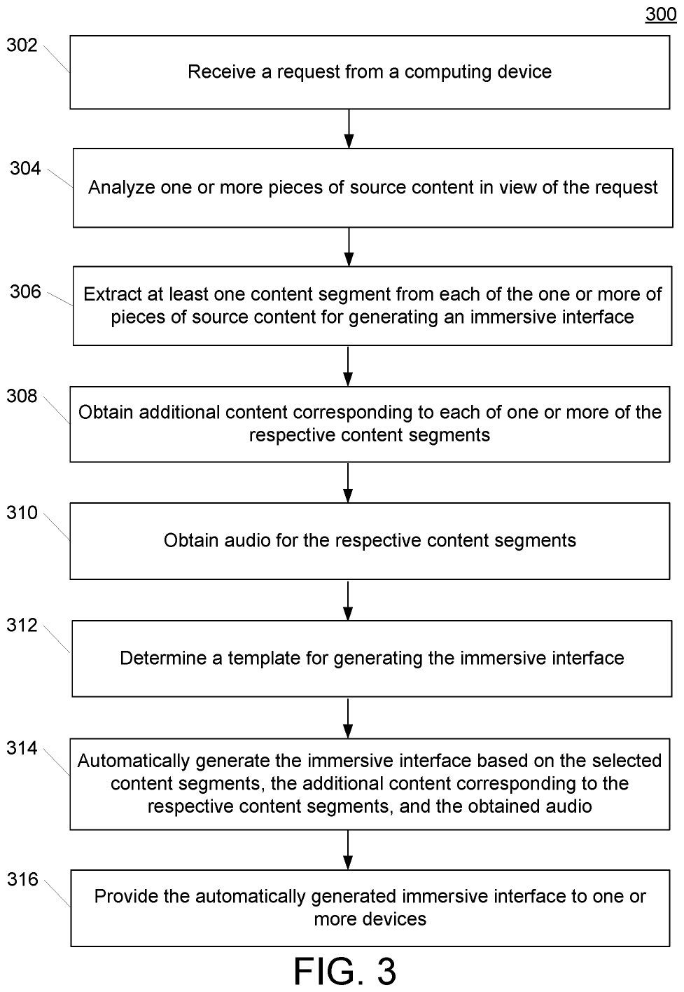

FIG. 3 depicts a flow diagram of an example method 300 for performing automatic generation of immersive interfaces in response to a user request in accordance with example embodiments of the present disclosure. Method 300 and the other processes described herein are shown as sets of blocks that specify operations performed but are not necessarily limited to the order or combinations shown for performing the operations by the respective blocks. As such, one or more of the various portions of the method 300 can be omitted, rearranged, combined, and/or adapted in various ways without deviating from the scope of the present disclosure.

One or more portions of method 300, and the other processes described herein, can be implemented by one or more computing devices such as, for example, one or more computing devices of a computing environment, for example, as illustrated in example computing environment 100 of FIG. 1 (e.g., one or more of server machine(s) 110, search server machine(s) 120, user device(s) 130, etc.). While portions of the following discussion may be made to a particular computing environment, such reference is made for example only. The operations are not limited to performance by one entity or multiple entities operating on one device or in any particular computing environment. As such, any one or more portions of these processes can be implemented as operations on the hardware components of the devices described herein.

At (302), a computing system receives a request from a computing device. In an example, immersive interface generation system 140 receives a request associated with a search query or any other type of request for information. In some examples, a request may be received based on selection of a hyperlink or user interface event. For example, a user may submit a request for information regarding one or more selectable topics, categories, channels, interests, or other selectable information presented via a user interface (e.g., one or more sports categories, types of food, recipes, health topics, nutrition topics, beauty topics, music, entertainment, news, etc.).

In one example, immersive interface generation system 140 analyzes a request and determines one or more sources of content to analyze based on the request. In some examples, immersive interface generation system 140 analyzes available sources of content and determines that one or more previously generated immersive interfaces correspond to the request. In some examples, immersive interface generation system 140 may return information about existing immersive interfaces in response to a request, for example, where one or more immersive interfaces have been pre-generated for a new event, topic, search, event, etc. For example, immersive interface generation system 140 of search server machine(s) 120 may generate immersive interfaces based on trending topics (e.g., top 1, 5, 10, n) associated with an internet or other type of search engine. As such, one or more pre-generated immersive interfaces then may be returned in response to related search queries or selection of such topics by a user.

In various examples, immersive interface generation system 140 analyzes information associated with a request to determine source content to analyze. For example, immersive interface generation system 140 may perform one or more types of processing on a request including, but not limited to, natural language processing. In some examples, immersive interface generation system 140 is used in association with search server machine(s) 120 and/or search indexes 122 to identify relevant source content and/or additional content to analyze based on a request. In some examples, immersive interface generation system 140 may analyze information associated with a request to determine one or more locations in data storage 116, 136, 150, content repositories, document management systems, partner systems, collections, pieces, and/or other to identify and obtain source content associated with a request. In some examples, immersive interface generation system 140 obtains and analyzes information from one or more license management software applications and/or systems, at least in part, to identify and obtain source content pertinent to a request.

At (304), a computing system analyzes one or more pieces of source content in view of the request. In an example, immersive interface generation system 140 locates, obtains, and analyzes one or more pieces of source content based on a request. In various examples, immersive interface generation system 140 locates and analyzes one or more pieces of source content that provide knowledge and facts related to subject matter associated with a request.

In various examples, one or more pieces of source content may be crowdsourced content (e.g., one or more Wikipedia® articles or other types of crowdsourced content in any language). Other examples of source content may include, but are not limited to, source content in any form (e.g., files, feeds, sheets, streams, etc.) obtained from any permissible source (e.g., created and/or otherwise owned by a user or organization, from partnering content providers or publishers, from licensors, from government agencies, from the public domain, etc.).

In various examples, immersive interface generation system 140 of the computing system analyzes source content and/or associated metadata to identify one or more pieces of source content comprising factual information or other data related to one or more items associated with a request. For example, immersive interface generation system 140 may identify relevant source content associated with a particular topic, subject, person, category, activity, article, recipe, news event, sporting event, etc. In addition, immersive interface generation system 140 may further analyze one or more pieces of identified source content associated with a request to identify particular segments from such source content to use in generating immersive interfaces. In some examples, immersive interface generation system 140 translates each of one or more pieces of source content into a standard or common language.

At (306), a computing system extracts at least one content segment from each of the one or more pieces of source content for generating an immersive interface. In an example, immersive interface generation system 140 analyzes each of one or more pieces of identified source content comprising factual information and/or data associated with a request. In various examples, immersive interface generation system 140 analyzes source content to identify one or more specific portions of each of one or more pieces of source content for use in generating an immersive interface.

In various examples, immersive interface generation system 140 extracts one or more content segments from each of one or more pieces of source content for generating content for an immersive interface. For example, immersive interface generation system 140 may extract one or more words, phrases, sentences, paragraphs, sections, and/or any other subset of content from each of one or more documents, such as long-form text documents, based on analyzing one or more pieces of source content. In an example, immersive interface generation system 140 generates a summary of extracted content segments for generating an immersive interface. In some examples, immersive interface generation system 140 analyzes various source content individually and/or collectively using one or more forms of natural language processing and extracts a summarization of selected content segments. For example, immersive interface generation system 140 may perform various types of processing to organize, order, reorder, consolidate, and/or otherwise generate a logical and cohesive summary from a collection of content segments in association with generating an immersive interface. In one example, immersive interface generation system 140 automatically analyzes one or more pieces of source content each comprising long-form text (e.g., 1, 10, 100, 1000, 10000, 100000, or any number of pages of text), extracts content segments based on the long-form text of the source content, and generates a brief summarization from the selected content segments (e.g., 4, 8, 12 sentences or phrases) for use in creating an immersive interface.

In various examples, immersive interface generation system 140 analyzes each of one or more sentences, phrases, or other segments of summarized source content to identify and assign a weighting to each of one or more entities, activities, and/or relationships in a piece of summarized source content. For example, people, objects, animals, scenes, locations, landmarks, activities, and/or other types of types of information may be identified in summarized source content based on analyzing text, audio, visual, and/or or other forms of summarized source content.

In an example, each of one or more entities, activities, and/or relationships in a particular piece of summarized source content may be weighted, for example, based on one or more of organization, ordering, position, prominence, duration, associations, interactions, and/or any other attributes or aspects of information determined based on analyzing a particular piece of summarized source content. In some examples, entities, activities, and/or relationships may be identified, extracted, and/or weighted based on information associated with a knowledge graph, knowledgebase, or any other type of system(s) or data structure(s) that provide information describing various attributes associated with entities, objects, events, relationships, situations, etc. In various examples, immersive interface generation system 140 utilizes identified and weighted entities, activities, and/or relationships from source content to identify additional content to match with the source content in an immersive interface.

At (308), a computing system obtains additional content corresponding to each of the one or more respective content segments. In an example, immersive interface generation system 140 automatically identifies and obtains additional content to include with each of the respective content segments in the target content based on identified and weighted entities, activities, and/or relationships found in the source content (e.g., original, modified, and/or summarized source content). For example, immersive interface generation system 140 may search for, locate, obtain, analyze, score, rank, compare, evaluate, and/or perform various other processing on additional content that is available and authorized for use to identify one or more pieces of additional content to include with particular pieces of source content in an immersive interface.

In various examples, immersive interface generation system 140 identifies one or more collections of additional content authorized and available to analyze based on information available from one or more license management, software applications and/or systems. For example, license management software applications or systems may provide information indicating additional content owned by a user or other party generating an immersive interface, additional content available from partnering organizations and publishers, additional content licensed from one or more other parties, additional content available from the public domain, and/or any other sources of additional licensed content authorized that permitted for use.

In various examples, immersive interface generation system 140 obtains and analyzes one or more pieces of additional content to determine additional content that will be matched and combined with a particular piece of selected source content in an immersive interface. For example, immersive interface generation system 140 may perform one or more queries based on entities, activities, relationships and/or other concepts identified in source content and their associated weightings to identify, analyze, score, and/or rank one or more pieces of additional content, such as images, videos, audio, and text based on how closely each of the pieces of additional content relate to selected source content.

Immersive interface generation system 140 may perform any type of visual, audio, or textual analysis to evaluate, score, and/or rank any piece of additional content. In some examples, immersive interface generation system 140 analyzes visual content using image segmentation, image classification, object detection, image recognition, object recognition, and/or any other type of analysis on additional content that is visual (e.g., images, videos, multimedia content with visual components, etc.) In some examples, immersive interface generation system 140 analyzes audio content to detect, recognize, interpret, identify or various types of sound, voices, noises, interactions, and/or any other aspects of additional content associated with audio (e.g., sound recordings, sound clips, sound associated with multimedia such as video, etc.) In some examples, immersive interface generation system 140 analyzes text, for example, using text processing, natural language processing, and/or any other type of processing to identify various aspects of additional content associated with text.

In an example, immersive interface generation system 140 selects one or more pieces of additional content for inclusion with a piece of source content in an immersive interface based on scoring, ranking, or otherwise evaluating attributes of the additional content in comparison to attributes of the piece of source content. In some examples, immersive interface generation system 140 selects one or more pieces of additional visual content, such as one or more images, one or more video segments or clips for inclusion with a particular piece of textual source content. Immersive interface generation system 140 also may select one or more pieces of additional audio content and/or additional text content for inclusion with a particular piece of source content.

At (310), a computing system generates audio for the respective content segments. In an example, immersive interface generation system 140 generates audio for one or more pieces of source content and/or one or more pieces of additional content for use in an immersive interface. For example, immersive interface generation system 140 may generate audio for each sentence or phrase in a piece of source content and/or in a piece of additional content. In some examples, immersive interface generation system 140, includes, and/or adds markup language to text and/or metadata associated with text. For example, immersive interface generation system 140 of the computing system may add speech synthesis markup language (SSML) or any other type of markup including, but not limited to, embedded speech commands, text-to-speech (TTS) markup, or any type of similar information that support the generation and playing of audio based on text. In some examples, immersive interface generation system 140 includes timestamp information, for supporting synchronized presentation of text or synchronized highlighting of text when corresponding text-to-speech audio is played in an immersive interface.

At (312), a computing system determines a template for generating the immersive interface. In an example, immersive interface generation system 140 determines and selects an immersive interface template to use for generating one or more immersive interfaces. For example, immersive interface generation system 140 may determine and select an immersive interface template from among multiple different immersive interface templates available for use. In some examples, immersive interface generation system 140 may determine and select one or more immersive interfaces templates to use automatically based on one or more of information associated with a request, one or more user preferences, user selection, information or attributes associated with source content, one or more content categories (e.g., news, articles, health, government, jobs, education, sports, art, entertainment, cooking, etc.) determined from source content and/or additional content, etc. In some examples, immersive interface generation system 140 may determine and select an immersive interface template automatically, by default, or based on user input.

In an example, immersive interface generation system 140 may determine and select an immersive interface template from among multiple immersive interface templates associated with a category and/or for a particular use. Immersive interface templates generally may provide support for generating immersive interfaces combining various forms of text, visual, and audio content. Immersive interface templates also may provide support for combining various forms of content in augmented reality and virtual reality interfaces. In general, immersive interface templates generally may provide a collection of one or more stylistic attributes associated with immersive interfaces, which may include attributes present in original content and/or stylistic attributes applied as part of an automated editing process. In various examples, immersive interfaces may provide predetermined or standardize formats for certain types of content based on stylistic attributes that generally may include, but are not limited to, layout, format, length, presentation, framing, positioning, sizing, ratios, angle, motion, focus, zoom, animation, transition, timing, automated navigation, user interface controls, video rate, color, lighting, audio rate, background images, attributions, notices, text, and/or any other attributes associated with various types of immersive interfaces.

At (314), a computing system automatically generates the immersive interface based on the selected content segments, the identified additional content corresponding to the respective content segments, and the generated audio. In an example, immersive interface generation system 140 automatically generates an immersive interface from a plurality of different source content segments based on automatically editing, blending, combining, sizing, resizing, and/or arrange each selected content segment and corresponding additional content (e.g., one or more pieces of additional visual, audio, and/or text content) in view of an immersive interface template to generate each new piece of target content for inclusion in an immersive interface. In some examples, immersive interface generation system 140 also combines generated audio, such as text-to-voice narration with each of one or more selected content segments and corresponding additional content when generating each new piece of target content for inclusion in an immersive interface.

In an example, immersive interface generation system 140 automatically generates each of one or more new pieces of target content for an immersive interface based on attributes and information associated with an immersive interface template. For example, an immersive interface template may include information regarding details for performing automated generation of an immersive interface. Such details may include, but are not limited to default and/or specific, background color(s), layering of elements, layout, placement of different types of content, aspect ratio, splash pages, default messages, default graphics, logos, branding, visual content placement and sizing, resolution and quality of visual content, formatting, sizing, automated advancement across immersive interface segments, aspects of one or more various stylistic attributes, language, localization, etc.

In an example, immersive interface generation system 140 automatically generates a new piece of target content for an immersive interface based on a selected content segment and its corresponding additional content. For example, immersive interface generation system 140 may analyze associated visual content and automatically determine and extract one or more relevant portions of the visual content. Immersive interface generation system 140 also may determine placement of text content to combine with the extracted visual content. In addition, immersive interface generation system 140 may determine and apply animation, graphics, audio, timing and/or other information for the new piece of content. In various examples, immersive interface generation system 140 may perform one or more other operations to blend, combine, or otherwise integrate one or more portions of a selected content segment with one or more portions of additional content, animation, effects, generated audio and/or other content to automatically create a new piece of target content for an immersive interface.

In an example, immersive interface generation system 140 automatically generates an immersive interface by integrating different pieces of target content automatically generated from selected source content, additional content, and or other sources into a single immersive user interface, such as a collection of display slides, multimedia slides, multimedia clips, and/or in other forms or arrangements as new content. In some examples, an immersive user interface may include any one or more of animation, timed or automated progression, transitions, etc. In various examples, immersive interface generation system 140 may generate a set of immersive display slides, multimedia slides, or multimedia clips for a user interface, such as a tile user (e.g., sliding tile) interface or an interactive story page. In some examples, immersive interface generation system 140 generates immersive interfaces that are provided to user device(s), allowing any user to view and understand the information being presented via immersion regardless of skill level or experience.

At (316), a computing system provides the generated immersive interface to one or more devices. In an example, immersive interface generation system 140 provides the generated target content to one or more computing devices for presentation, display, and/or communication, to one or more users. In some examples, immersive interface generation system 140 may provide one or more immersive interfaces to search server machine(s) 120 for indexing and ranking. For example, search server machine(s) may analyze, index, rank, publish, and/or provide one or more generated immersive interfaces to one or more computing devices in response to a search query or other requests. Immersive interface generation system 140 may automatically generate one or more immersive interfaces, for example, in response to a request or in advance of receiving a request. In some examples, immersive interface generation system 140 may update one or more generated immersive interfaces based on information associated with the user request. For example, immersive interface generation system 140 may converted, transform, update, and/or otherwise modify one or more existing immersive interfaces based on information including, but not limited to, preferences of a user, detecting a language associated with a user or request, receiving location information from a device associated with a request, and/or any other information that allows immersive interface generation system 140 to automatically transform and tailor new and/or existing immersive interfaces for a particular user or group of users based on available information.

In various examples, immersive interface generation system 140 may provide immersive interfaces in one or more forms including, but not limited to, as an animated tile in a tile-based user interface, as content in a feed, as a post on social media, as carousel user interface or post, as a set of story pages, and/or generally as part of any other type of user interface or in any other forms for communication to users. In some examples, immersive interfaces may be provided as accelerated mobile pages and/or in a web story format that blends various audio, video, image, graphics, animation, and/or text. In some examples, users and content publishers may store generated immersive interfaces in data storage 150 (e.g., cloud storage), and share, post, publish or otherwise communicate generated immersive interfaces via social media sites, content sharing sites, news sites, and/or via other various types of computing systems, services, and networks.

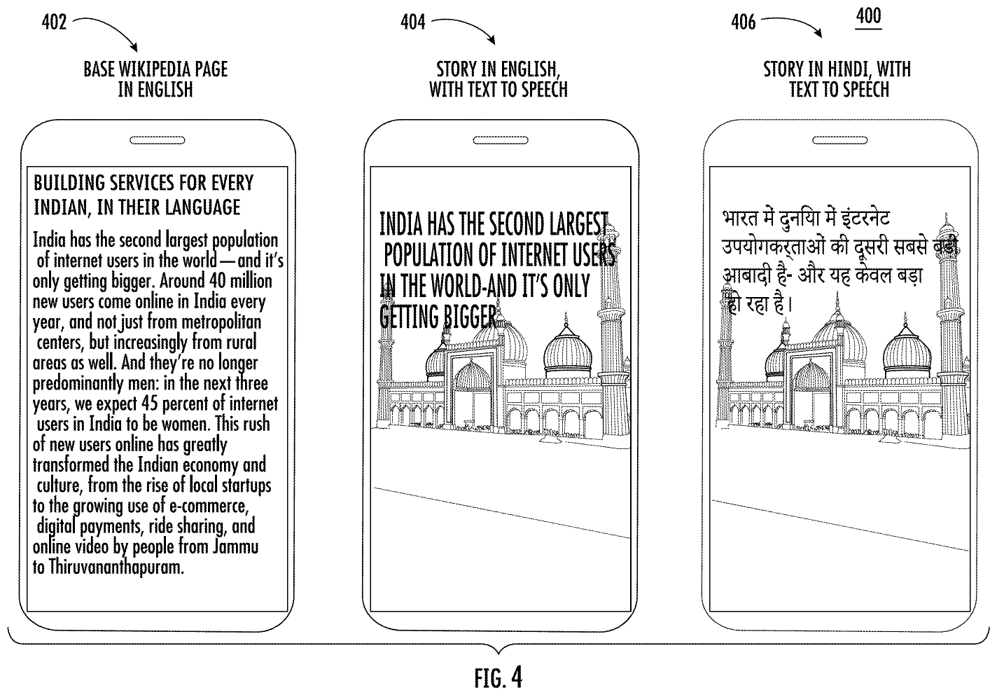

FIG. 4 depicts example illustrations 400, including two example immersive interfaces generated from an example piece of long-form text source content in accordance with example embodiments of the present disclosure. Example illustrations 400 include an example piece of long-form text source content 402 displayed on a mobile device, an example portion of an immersive interface 404 automatically generated in one language based on the long-form text source content 402, and an example portion of a second immersive interface 406 generated in another language based on the long-form text source content 402.

In an example, immersive interface generation system 140 receives a request to generate one or more immersive interfaces. For example, the request may comprise information about long-form text source content 402 and/or other pieces of source content. The request also may be a search query pertaining to malaria or a command from a content provider or other user to generate immersive content about malaria. In an example, immersive interface generation system 140 may locate and utilize long-form text source content 402 to generate one or more immersive interfaces associated with malaria. In one example, immersive interface generation system 140 automatically generates an immersive interface for malaria from long-form text source content 402 in English (e.g., comprising example portion of an immersive interface 404). In one example, immersive interface generation system 140 automatically generates an immersive interface for malaria from long-form text source content 402 in Hindi (e.g., comprising example portion of the second immersive interface 406).

In an example, immersive interface generation system 140 automatically generates an immersive interface in one language (e.g., English) and/or for a particular geography (e.g., United States) or locale (e.g., Florida) based on long-form text source content 402. In another example, immersive interface generation system 140 automatically generates an immersive interface in a different language (e.g., Hindi) and/or for a different geography (e.g., India) or locale (e.g., New Delhi) based on long-form text source content 402. For example, different versions of an immersive interface may be generated based on location information associated with a request, user preferences, information associated with a user account, etc.

In an example, immersive interface generation system 140 generates a new immersive interface based on an existing immersive interface. In one example, immersive interface generation system 140 may automatically generate the immersive interface in Hindi based on an existing immersive interface in English. For example, immersive interface generation system 140 may automatically translate language of an existing immersive interface to a different language for a new immersive interface based on location information or preference of a user associated with a request. Additionally or alternatively, the system may summarize the content again using a locale specific summarization engine. This allows the system to reduce the text complexity (e.g., sentence structure, vocabulary, terms) introduced by the translation. Immersive interface generation system 140 also may utilize a different immersive interface template associated with a particular country or locale to generate the new immersive interface. In addition, immersive interface generation system 140 also may identify and utilize new additional content associated with a particular country or locale that are familiar and understandable to a user (e.g., country or locale-specific visual content, audio content, text-to-speech, narration, etc.) when generating the new immersive interface. By way of example, the system may use locale specific content such as images or videos associated with a particular region. As a specific example, the system may use an image of a farmer from Nebraska for a user in the United States and an image of a farmer from Thailand for a user in Thailand.

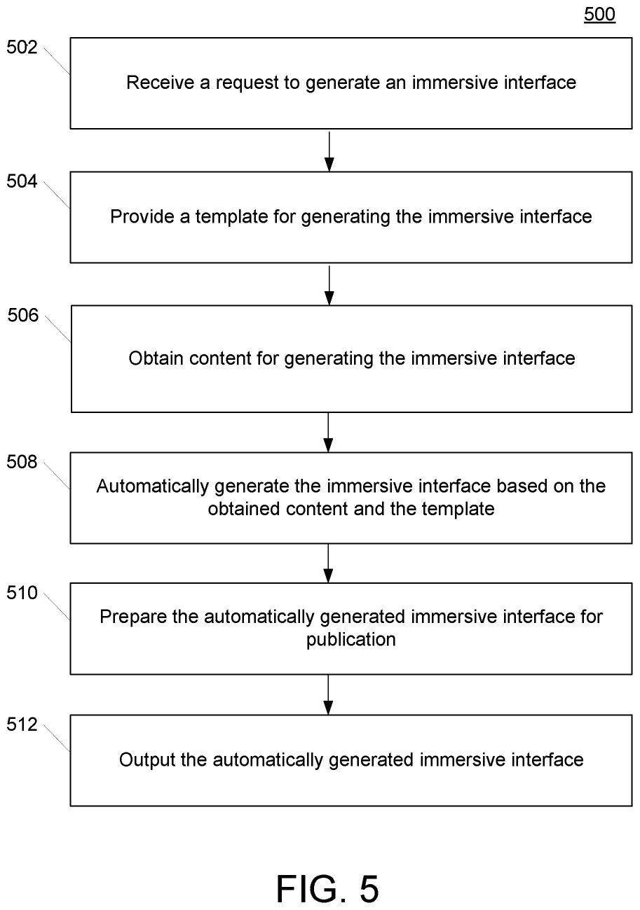

FIG. 5 depicts a flow diagram of an example method 500 for processing a request to generate an immersive interface in accordance with example embodiments of the present disclosure. Method 500 and the other processes described herein are shown as sets of blocks that specify operations performed but are not necessarily limited to the order or combinations shown for performing the operations by the respective blocks. As such, one or more of the various portions of the method 500 can be omitted, rearranged, combined, and/or adapted in various ways without deviating from the scope of the present disclosure.

One or more portions of method 500, and the other processes described herein, can be implemented by one or more computing devices such as, for example, one or more computing devices of a computing environment, for example, as illustrated in example computing environment 100 of FIG. 1 (e.g., one or more of server machine(s) 110, search server machine(s) 120, user device(s) 130, etc.). While portions of the following discussion may be made to a particular computing environment, such reference is made for example only. The operations are not limited to performance by one entity or multiple entities operating on one device or in any particular computing environment. As such, any one or more portions of these processes can be implemented as operations on the hardware components of the devices described herein.

At (502), a computing system receives a request to generate an immersive interface. In some examples, the computing system can include a content platform that provides content to users of user devices (e.g., user device 130 in FIG. 1). In an example, immersive interface generation system 140 receives a request to generate one or more immersive interfaces. For example, the request may be received from a content owner, content publisher, organization, individual user, and/or any other type of entity seeking to generate immersive interfaces based on any existing, authorized content. In an example, a request may be received in association with any type of software application, site, or system that provides social media, content sharing, image or photo sharing, video sharing, content publication, content editing, and/or any other types of services.

In various examples, immersive interface generation system 140 allows any number of users or entities (1, 10, hundreds, thousands, millions, etc.) to generate immersive interfaces using their own content and/or other authorized content permitted by one or more other parties. As an example, access to immersive interface generation system 140 services may be provided directly or indirectly to users via computing devices, application (e.g., application(s) 132), user interface (e.g., user interface(s) 134), websites, computing systems, application programming interfaces (APIs), network services, etc. In some examples, a request may include information indicating one or more immersive interface templates and/or information about one or more pieces of source content to use for generating immersive interfaces.

In some examples, the system enables users to review, approve, edit, publish, or download an immersive interface generated by the system. The immersive interface may be hosted locally by a user, publisher, and/or remotely by the immersive interface generation system. In another example, a search server machine 120 may expose the immersive interface generation system capabilities in a Search Console. In a way similar to a video or image search experience, users can be notified when new content is available based on their existing content. After reviewing the content, they may edit, publish, download, or even approve it for other purposes (e.g., showing it in search results or other screens/apps).

At (504), a computing system provides one or more immersive interface templates for selection. In an example, immersive interface generation system 140 provides one or more immersive interface templates that may be selected for generating immersive content. For example, a user may be presented with one or more immersive interface templates to select for generating immersive interfaces using their own content and/or other authorized content. Immersive interface templates may be grouped together for presentation to a user, for example, based on subject matter, channels, influencers, creators, and/or categories such as news, articles, health, government, jobs, education, sports, art, entertainment, cooking, travel, sports, exercise, etc.

In an example, at least one immersive interface template may be selected by default. In some examples, immersive interface generation system 140 receives a selection of an immersive interface template and uses the selected template to generate an immersive interface. Immersive interface generation system 140 also may use a one or more default immersive interface templates to generate corresponding immersive interfaces. In some examples, immersive interface generation system 140 receives a selection of multiple immersive interface templates and generates a different immersive interface using each immersive interface template based on common source content, for example, to allow a user to compare, select, publish, share, and/or discard one or more of the generated immersive interfaces.

At (506), a computing system receives user content for generating the immersive interface. In an example, immersive interface generation system 140 receives information from a user about one or more pieces of source content to use for generating one or more immersive interfaces. For example, a user may provide one or more pieces of text, image, photo, audio, and/or video source content. In some examples, source content may be user-generated content associated or shared with a user account. In some examples, a user may specify one or more particular pieces of source content. A user also may provide a location comprising one or more collections of source content. In an example, a user provides information about source content and/or source content itself from an account associated with photo sharing services, video sharing services, storage services, social media, and/or one or more other services, which immersive interface generation system 140 may access and utilize to automatically generate immersive interfaces from source content. In one example, source content may include, but not limited to, user-generated or user-provided documents, text, writing, social media posts, images, pictures, photos, videos, sound recordings, etc.

At (508), a computing system automatically generates the immersive interface from the user content based on a selected immersive interface template. In an example, immersive interface generation system 140 analyzes source content, selects one or more content segments from each piece of source content, summarizes the selected content segments, divides the summarized selected content into multiple pieces, identifies and assigns respective weights to each of one or more objects, activities, and/or relationships present in each piece of summarized content, identifies and scores additional content related to each piece of summarized content to include with respective content segments in an immersive user interface, determines one or more pieces of additional content to combine with each piece of summarized content based on the scoring or ranking associated with the scoring, generates text-to-speech for text associated with one or more pieces of summarized content and/or corresponding additional content, generates a piece of target content for an immersive interface by combining each piece of summarized content with corresponding additional content and generated text-to-speech, and creates the immersive interface based on integrating the generated target content into an immersive interface.

At (510), a computing system prepares the automatically generated immersive interface for publication. In an example, immersive interface generation system 140 allows users to preview, select, approve, store, update, regenerate, discard, and/or perform one or more other actions associated with automatically generated immersive interfaces. In some examples, immersive interface generation system 140 allows a user to select one or more of multiple automatically generated immersive interfaces for storage and/or publication. In some examples, immersive interface generation system 140 provides automatically generated immersive interfaces to search server machine(s) 120 for analysis, indexing, and/or ranking. In some examples, immersive interface generation system 140 also may provide immersive interface generation system 140 to server machine(s) 110 for publication and/or distribution, for example, in response to requests from user device(s) 130.

At (512), a computing system provides the automatically generated immersive interface to one or more computing devices. In an example, immersive interface generation system 140 outputs or otherwise transmits automatically generated immersive interfaces to one or more computing devices (e.g., server machine(s) 110, search server machine(s) 120, user device(s) 130, and/or any other type of computing device) for presentation, display, communication, or any other type of delivery to one or more users. The immersive interface can be hosted on one or more servers in some examples using traditional content hosting techniques. The immersive interface can also be made locally and shareable without involving servers.

### Example Devices and Systems

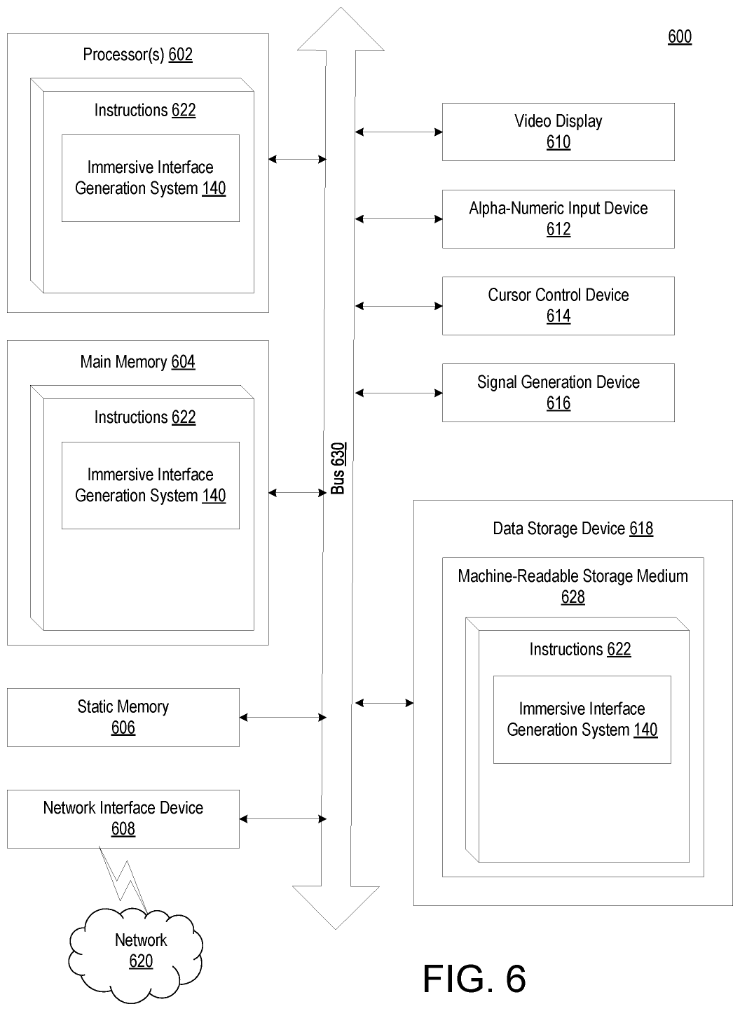

FIG. 6 illustrates a diagram of an example machine in the form of a computer system 600, within which a set of instructions for causing the machine to perform any one or more of the operations discussed herein may be executed. In other examples, the machine may be connected (e.g., networked) to other machines in a LAN, an intranet, an extranet, or the internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a wearable computing device, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the operations discussed herein.

Computer system 600 includes at least one processing device (e.g., processor(s) 602), a main memory 604 (e.g., read-only memory (ROM), flash memory, dynamic random-access memory (DRAM) such as synchronous DRAM (SDRAM), double data rate (DDR SDRAM), or DRAM (RDRAM), etc.), a static memory 606 (e.g., flash memory, static random-access memory (SRAM), etc.), and a data storage device 618, which communicate with each other via a bus 630.

Processor(s) 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 also may be one or more special-purpose processing devices such as an application specific integrated circuit (ASIC), a field programmable gate array (FPGA), a digital signal processor (DSP), network processor, or the like. The processor 602 is configured to execute instructions 622 for performing the operations discussed herein.

The computer system 600 also may include a network interface device 608. The computer system 600 may further include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

The data storage device 618 may include a computer-readable storage medium 628 on which is stored one or more sets of instructions 622 (e.g., software computer instructions) embodying any one or more of the examples described herein. The instructions 622 also may reside, completely or at least partially, within the main memory 604 and/or within the processor 602 during execution thereof by the computer system 600, the main memory 604 and the processor 602 also constituting computer-readable storage media. The instructions 622 may be transmitted or received over a network 620 via the network interface device 608.

In one example, the instructions 622 include instructions for one or more modules of an automated immersive interface generation system (e.g., immersive interface generation system 140 of FIG. 1) and/or a software library containing methods that call immersive interface generation system 140. While the computer-readable storage medium 628 (machine-readable storage medium) is shown as an example to be a single medium, the term “computer-readable storage medium” should be taken to include a single medium, or multiple media (e.g., a centralized or distributed database, and/or associated caches and servers) that store the one or more sets of instructions. The term “computer-readable storage medium” also may include any medium that is capable of storing, encoding, or carrying a set of instructions for execution by the machine and that cause the machine to perform any one or more of the operations of the present disclosure. The term “computer-readable storage medium” shall accordingly be taken to include, but not be limited to, solid-state memories, optical media, and magnetic media.

Numerous details are set forth in the foregoing description. However, it will be apparent to one of ordinary skill in the art having the benefit of this disclosure that the present disclosure may be practiced without these specific details. In some instances, well-known structures and devices are shown in block diagram form, rather than in detail, to avoid obscuring the present disclosure.

Some portions of the detailed description have been presented in terms of processes and symbolic representations of operations on data bits within a computer memory. Here, a process is generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “analyzing,” “determining,” “identifying,” “adjusting,” “transmitting,” “receiving,” “processing” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain examples of the present disclosure also relate to an apparatus for performing the operations herein. This apparatus may be constructed for the intended purposes, or it may comprise a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other examples will be apparent to those of skill in the art upon reading and understanding the above description. The scope of the disclosure therefore should be determined with reference to the appended claims, along with the full scope of equivalents to which such claims are entitled.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method, comprising:
analyzing, by one or more processors, a web-based resource comprising textual content;
extracting, by one or more processors, a plurality of textual content segments from the web-based resource;
obtaining, by the one or more processors for each textual content segment of the plurality of textual content segments, visual content and audio content related to each respective textual content segment;
generating, by the one or more processors, target content for an audio-visual display of the web-based resource, wherein generating the target content comprises combining at least a portion of each respective textual content segment from the plurality of textual content segments with the visual content and the audio content related to the respective textual content segment; and
providing, by the one or more processors, data descriptive of the generated target content to a computing device for presentation of the audio-visual display of the web-based resource.

2. The computer-implemented method of claim 1, further comprising:
obtaining, by the one or more processors, the web-based resource based at least in part on information associated with a request.

3. The computer-implemented method of claim 2, wherein the request is a search query received from a computing device.

4. The computer-implemented method of claim 3, wherein the data descriptive of the generated target content is provided in response to the search query.

5. The computer-implemented method of claim 1, further comprising:
determining, by the one or more processors, a template for generating the target content for the audio-visual display of the web-based resource, and
wherein the generating of the target content for the audio-visual display of the web-based resource is based at least in part on the determined template.

6. The computer-implemented method of claim 1, further comprising:
generating, by the one or more processors, the audio content based on converting one or more of the textual content segments to speech.

7. The computer-implemented method of claim 1, further comprising:
analyzing, by the one or more processors, each of the textual content segments from the web-based resource; and
determining, by the one or more processors for each textual content segment of the plurality of textual content segments, a weighting for one or more items identified respectively in each textual content segment.

8. A computing system, comprising:
a non-transitory computer-readable medium; and
one or more processors communicatively coupled to the non-transitory computer-readable medium, wherein the one or more processors execute instructions from the non-transitory computer-readable medium that cause the computing system to:
analyze a web-based resource comprising textual content;
extract a plurality of textual content segments from the web-based resource;
obtain for each textual content segment of the plurality of textual content segments, visual content and audio content related to each respective textual content segment;
generate target content for an audio-visual display of the web-based resource, wherein generating the target content comprises combining at least a portion of each respective textual content segment from the plurality of textual content segments with the visual content and the audio content related to the respective textual content segment; and
provide data descriptive of the generated target content to a computing device for presentation of the audio-visual display of the web-based resource.

9. The computing system of claim 8, wherein the computing system further is to:
obtain, by the one or more processors, the web-based resource based at least in part on information associated with a request.

10. The computing system of claim 9, wherein the request is a search query received from a computing device.

11. The computer-implemented method of claim 10, wherein the data descriptive of the generated target content is provided in response to the search query.

12. The computing system of claim 8, wherein the computing system further is to:
determine a template for generating the target content for the audio-visual display of the web-based resource, and
wherein the target content for the audio-visual display of the web-based resource is generated based at least in part on the determined template.

13. The computing system of claim 8, wherein the computing system further is to:
generate the audio content based on converting one or more of the textual content segments to speech.

14. The computing system of claim 8, wherein the computing system further is to:
analyze each of the textual content segments from the web-based resource; and
determine for each textual content segment of the plurality of textual content segments, a weighting for one or more items identified respectively in each textual content segment.

15. A non-transitory computer-readable medium having instructions that, when executed by one or more processors associated with a computing device, cause the computing device to:
analyze a web-based resource comprising textual content;
extract a plurality of textual content segments from the web-based resource;
obtain for each textual content segment of the plurality of textual content segments, visual content and audio content related to each respective textual content segment;
generate target content for an audio-visual display of the web-based resource, wherein generating the target content comprises combining at least a portion of each respective textual content segment from the plurality of textual content segments with the visual content and the audio content related to the respective textual content segment; and
provide data descriptive of the generated target content to a computing device for presentation of the audio-visual display of the web-based resource.

16. The non-transitory computer-readable medium of claim 15, wherein the computing device further is to:
obtain the web-based resource based at least in part on information associated with a request.

17. The non-transitory computer-readable medium of claim 16, wherein the request is a search query received from a computing device and the data descriptive of the generated target content is provided in response to the search query.

18. The non-transitory computer-readable medium of claim 15, wherein the computing device further is to:
determine a template for generating the target content for the audio-visual display of the web-based resource, and
wherein the target content for the audio-visual display of the web-based resource is generated based at least in part on the determined template.

19. The non-transitory computer-readable medium of claim 15, wherein the computing device further is to:
generate the audio content based on converting one or more of the textual content segments to speech.

20. The non-transitory computer-readable medium of claim 15, wherein the computing device further is to:
analyze each of the textual content segments from the web-based resource; and
determine for each textual content segment of the plurality of textual content segments, a weighting for one or more items identified respectively in each textual content segment.
